(19) United States
(12) Patent Application Publication
(10) Pub. No.: US 2016/0021836 A1
(43) Pub. Date: Jan. 28, 2016

(54) AEROPONIC GROWTH SYSTEM WIRELESS CONTROL SYSTEM AND METHODS OF USING

(71) Applicant: AESSENCE CORPORATION, Mountain View, CA (US)

(72) Inventor: KENT KERNAHAN, CUPERTINO, CA (US)

(21) Appl. No.: 14/341,781

(22) Filed: Jul. 26, 2014

(51) Int. Cl. A01G 25/16; H04L 29/08; H04W 4/00; G05B 15/02

(52) U.S. Cl. CPC A01G 25/16; G05B 15/02; H04L 67/10; H04W 4/005

(57) ABSTRACT

A reliable aeroponic plant growing system provides a wireless connection between its subsystems for the exchange of data and commands. The various subsystems manage one or more plant growing atriums, to include misting of roots, maintenance of water levels, addition of various nutrients, and light cycling.

### RELATED APPLICATIONS

This application is related to commonly-owned U.S. patent application Ser. No. 14/339,015, submitted Jul. 23, 2014, by Kent Kernahan, which is incorporated herein by reference in its entirety, herein after “the '015 disclosure”. This application is also related to commonly owned U.S. patent application Ser. No. 14/341,774 submitted Jul. 25, 2014, by Kent Kernahan, which is incorporated herein by reference in its entirety, herein after “the '774” disclosure.

### BACKGROUND

Aeroponics is the technique of growing plants by providing droplets of water, and possibly water with nutrients, to plant roots, wherein the droplets are smaller than the pore size of the roots.

An aeroponic growth system generally comprises a system for delivery of nutrient-rich water to one or more plants, light, and fresh air. The system may be outdoors, in a green house, or may be within a facility that includes the provision of light for plant growth, and centralized delivery of water and electrical power.

Such facilities may be constructed on a large scale, covering thousands of square feet. The facility may be configured to produce a variety of crops, or just one. Between setup (planting) and harvest time there is little need for human attendance save for checking to insure that all is well. However sometimes the crop is very valuable, and may be lost if certain problems persist for a fairly short time. Due to the power requirements for light and distribution of water a significant amount of heat may be generated. Such heat may be generally removed by the proper use of fans, for example, but heat that is localized in a small area may destroy some amount of a valuable crop in spite of the general heat-removal system. Likewise if light is lost to a localized area the crop in that area may under-produce its expected value.

A large aeroponic facility may be constructed using growing systems that are much smaller than the facility, for example just a few feet on a side. These systems generally include some automated means for periodically providing water or mist to the plant roots, refilling a reservoir, and managing light cycles and intensity. In a facility that may include thousands of growing systems it can be labor intensive to monitor for proper operation of each one. Such systems may also be inflexible.

What is needed is a facility-wide system to control and monitor the facility at large as well as each growing system to insure proper operation and safety. It would be advantageous to also report status and various operational conditions to a central location within or away from the facility. It would also be desirable to provide for remotely altering the control programs of the growing systems.

### SUMMARY

The present disclosure describes a system for a control system for a single growth system, expandable to a large facility comprising an essentially unlimited number of growth systems. It is assumed that all growth systems are provided with adequate water from a central supply and power external to an individual growth system. A system comprises a removable sensor system and supporting power collar (or “cradle”); electronics instantiated within the growth system; an uninterruptable power supply (“UPS”); a link server for system wide control; a lighting system including monitoring of power and fire detection; wired communications between systems in a common enclosure; and a wireless infrastructure, for example a Wi-Fi system including transceivers, access points, router, gateway and internet access. There may also be optional equipment also capable of wireless communications.

The apparatus required for one embodiment of the present disclosure will be disclosed, followed by a disclosure of the various connectivity paths and control systems.

### BRIEF DESCRIPTION OF THE DRAWINGS

The accompanying drawings, which are incorporated herein and constitute part of this specification, illustrate exemplary aspects of the invention, and, together with the general description given above and the detailed description given below, serve to explain features of the invention.

FIG. 1 shows all major systems for a complete aeroponic growth system and the communications paths between them.

FIG. 2 shows the various pumps and valves being controlled.

FIG. 3 is a detail of an electronic control subsystem.

FIG. 4 is a diagram of an LEF system.

FIG. 5 shows a water and nutrient distribution system.

FIG. 6 is a list of symbols used in FIG. 5.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

### Apparatus

An aeroponic growth system will be referred to as an “atrium” 190, which includes the electronics and various mechanical systems embodied in an enclosure including a water reservoir and a top, wherein the plants being grown generally are kept in a basket-type device with the roots extending down towards the bottom of the reservoir. In some systems there is little water; the box is to provide a volume for the roots to occupy. The systems providing the present invention may comprise a portable, wireless sensor system 160 and a collar 170 affixed to a container for the water, nutrients, and various pumps and other equipment 180 for growing plants according to the aeroponic methodology 190. A system referred to as a “LEF” 110, or Lights, Exhaust gas temperature, and Fan control includes lighting equipment, a wireless communications device, temperature sensor, fire detector, fan, and input terminals for mains power. Some number of access points 102 are connected to a router 101 connected to a LAN/WAN 103 and may also connect to a local console 104 and another router providing firewall protection 015 and eventually connection to the internet 107. A link server 150 may include wireless capability, and be in communication with all other appliances on the network, whether via Wi-Fi or wired via a wireless node.

In some embodiments there is optional equipment, some, all or none of which may be utilized at a given installation. Examples include a smart tablet or phone 120, a camera 130, and a roving sensor 140. The atrium 190 may be contained in a single enclosure, which may include some overhead support structures. The system 190 may include a QR code conveniently placed where the tablet or smart phone 120 or camera 130 may read the QR code and report it to the link server 150, thereby making an association of a specific system 190. An electronic serial number (“ESN”) in the collar 170 makes a logical association between the system 190 and the instant WAND 170. A QR code emblem in the LEF 110 may be used in the same manner.

A system referred to as a “WAND” 160, an acronym for Water, Air, Network Device, may be provisioned with a variety of sensors according to the system designer's need. In some embodiments of the instant disclosure the WAND 160 comprises air sensors for CO2, CO, and O2, and a sensor for ambient light. The WAND 160 may also comprise water sensors, for sensing pH, temperature, TDS (total dissolved solids) or resistivity.

The WAND 160 may be completely devoid of internal power, instead be inserted into a collar 170 wherein the collar induces power into the WAND 160 via proximate coils. Such an arrangement enables a system to be built and used wherein the WAND 160 is easily removable for a variety of reasons. Examples include replacement due to failure or changing the sensor complement of a given WAND 160, therefore growth system 190.

WANDs 160 may be configured with wireless communications capability, thereby acting as a gateway. Wired communications are sometimes provided by inductively communicating between the WAND and the collar 170, the collar 170 in turn connected to other devices within the growth system 190 by any means. The collar 170 includes an ESN, which may then be used to identify a given growth system 190 to the link server 150. Further details regarding the WAND 160 and the collar 170 may be found in the ‘774 disclosure.

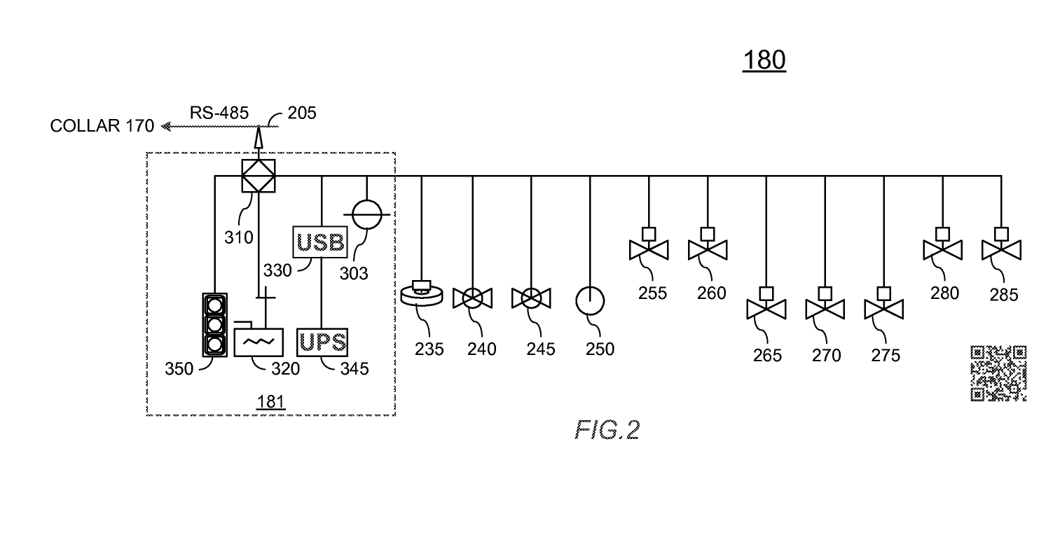

Looking to FIG. 2, detailing the subsystems 180 associated with the atrium 190, an RS-485 bus 205 provides for communication between the atrium electronics 181 and the collar 170.

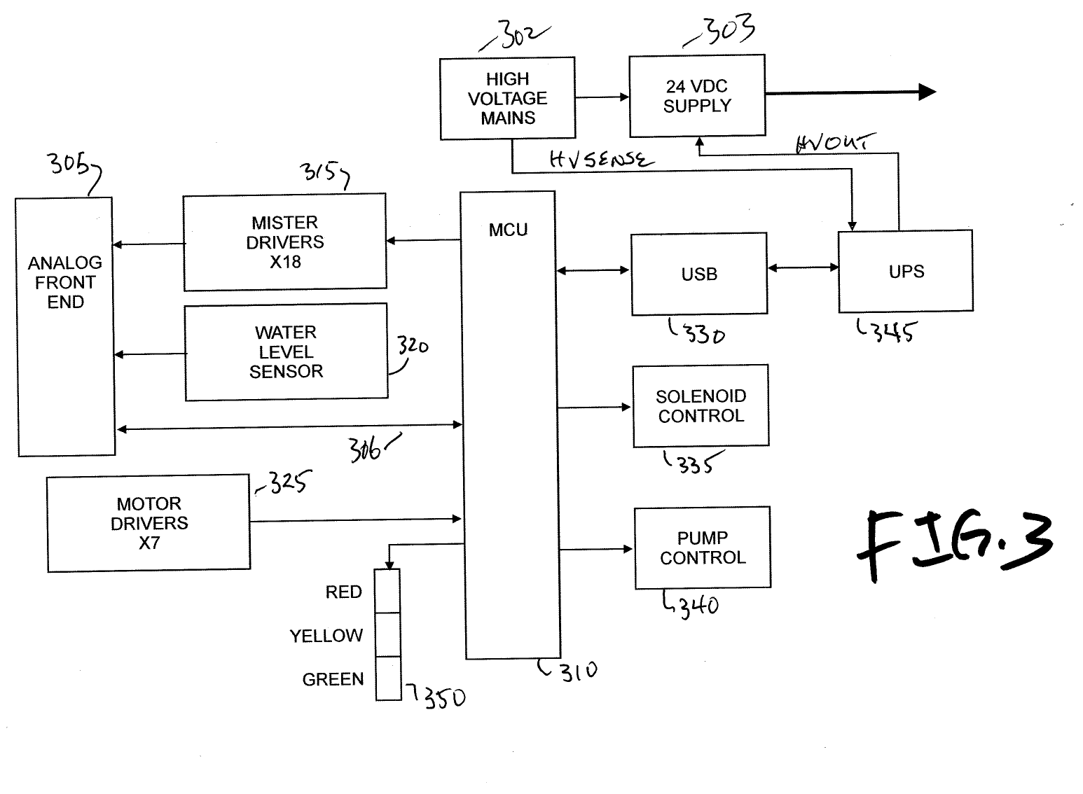

Looking to FIG. 3, the ACE (atrium chamber electronics) 181 comprises a mister system 235; a pump for mixing and siphon priming 240; a valve to a water source 245; two pumps to water misters, one for a first bank 255 and one for a second bank 260; and five canister dispensing pumps with check valves. The canisters may be for the following nutrients (FIG. 2): phosphate 265; nitrogen 270; potassium 275; acid for pH decreasing 280; and a base for increasing pH 285. The ACE 181 also includes a status/warning light 350.

An MCU 310 manages the various sensors and drivers in order to control the hardware systems within the atrium 190. Mains power 302 is provided to the system from the facility in which it is operated. The mains 302 provide high voltage, for example 120 VAC to a 24 VDC converter 303. The 24 VDC converter 303 provides operating power to the downstream pumps. A UPS 345 senses the output of the mains 302, and under certain conditions, for example power failure, takes over and provides 120 VAC to the 24 VDC supply, which continues to operate until either power is restored to the mains 302 or the UPS 345 unit's battery fails, and which time the entire atrium 190 fails. The UPS 345 system provides a unique safety backup similar to how data centers are configured to be failure resistant.

The UPS 345 may communicate with the MCU 310 via a USB line 330, providing data as to the condition of the mains 302 level and the state of the UPS 345 backup battery.

Consider an atrium 190 comprising nine plant locations in nine plant baskets. Each plant is provided with two transducers to generate mist for the roots from two small reservoirs holding the water or water enriched with nutrients. In one embodiment eighteen mister drivers 315 provide control signals to the eighteen transducers. Signals from the mister drivers are provided to an analog front end 305, wherein the signals are converted to digital versions of the analog signals and provided to the MCU on a bus 306. The data is used by the MCU to determine if a transducer has gone bad or a reservoir gone dry, causing the transducer to shut down.

A motor driver 325 includes seven outputs for driving pumps, for example peristaltic pumps. For backup, the nine misters comprising two small water reservoirs per plant are refilled by two different pumps 255, 260 such that if one side fails to all nine mister reservoirs the other pump will likely still be operable. The other five motor driver 325 output signals control individual canister pumps wherein each canister contains a liquid or gel nutrient. For example, in one embodiment the five canister pumps are assigned to canisters holding phosphate 265; nitrogen 270; potassium 275, an acid to decrease pH 280; and a base to raise the pH.

A water level sensor 320, for example an eTape Water Level Sensor, provides a signal voltage that varies with how much water the sensor 320 is covered by. The water level sensed is the main water reservoir of the atrium 190.

The status light system 350 provides different color lights which may be turned on by the system to identify status or problems. An example component is a QLight St56ECF-BZ-1, available from QLight, 185-25, Mukbang-ro, Sangdong-myeon, Gimhae-si, Gyeongsangnam-do 621-812 Korea. The light 350 may signal such conditions as good, a warning that the water level is low but useable, or an out of service condition such as failure of the mister pumps (255, 260).

A solenoid controller 335 controls a valve for adding water 245 and another valve for priming the draining tube 240. There is also a pump control for operating a circulation/draining pump 250.

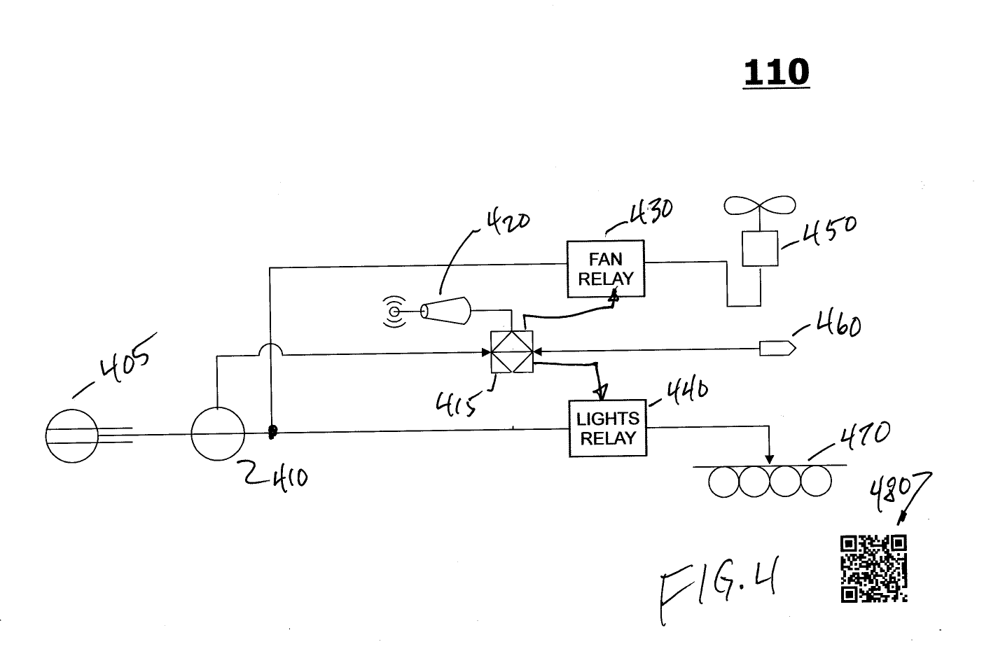

FIG. 4 is an example of a system referred to as a Lights, EGT, and Fan system or “LEF” 110. The LEF 110 performs several functions wirelessly other than the mains power 405 provided by the facility in which it is installed.

AC power is delivered 405 to a relay 440 for turning on lights 470. The lights 470 maybe be any suitable lighting technology. A controller system 415 includes components for rectification and voltage reduction as needed. The controller 415 may comprise an MCU for controlling the system 110 and an analog front end or other ADC functionality. A contactless AD voltage and current sensor 410 provides signals to the ADC within the controller 415. AC mains power 405 may also be provided to a fan 450, enabled or disabled by a relay 430 under the control of the controller 415. A temperature sensor 460 for sensing the local temperature provides its signal to the ADC of the controller 415.

A two-way wireless device 420, for example a Wi-Fi transceiver, may be connected to the controller 415, thereby enabling the controller 415 to report the LEF 110 status to the link server 150 or to receive a recipe or commands from the link server 150. A QR sticker 480 may be viewed by the smart device 120 or camera 130 to associate the instant LEF with a particular atrium 190 or position in the facility.

The controller may perform several functions beyond energizing and de-energizing relays. For example, the controller 415 may read the temperature from sensor 460 and if the temperature is above a predetermined value turn on the fan 450 until the temperature returns to a desirable value. The controller may also have a predetermined cycle of turning the lights 470 ON and OFF per instructions from the link server 150. In some embodiments other sensors may be provided, for example a CO detector or fire detector for protection of the atrium, facility, or human staff.

### Communication and Control

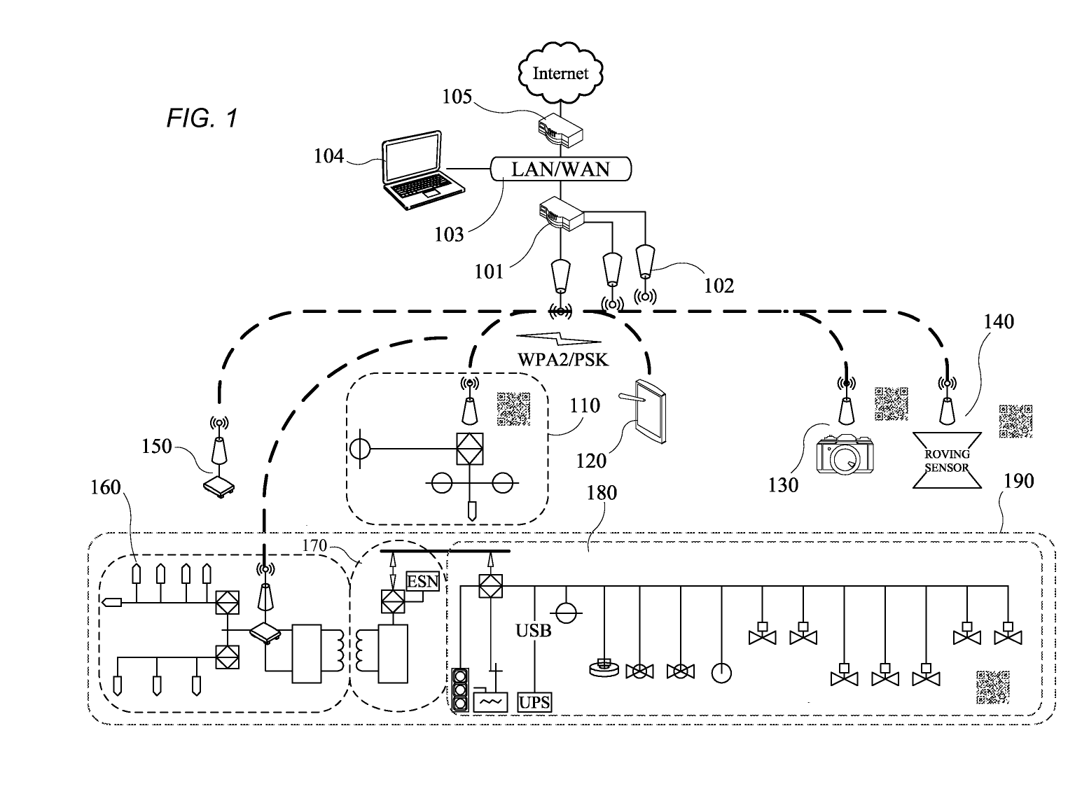

The system of FIG. 1 may be related to just one atrium in service. However it may be deployed in a large plant growing facility, thereby providing efficiency by amortizing the cost of some components over a larger number of atriums 190. The key component in the system 100 is a link server 150. The link server may support any wireless technology, such as Wi-Fi or a proprietary technology. In some embodiments all of the communication equipment is off the shelf components, configured as a unique command and control system.

A key component of the system 100 is a link server 150. The link server may be designed in a variety of ways, for example a programmed Raspberry Pi. Strictly for the purpose of illustration, a Wi-Fi based system has been arbitrarily selected to be an example for the instant disclosure.

The link server performs a variety of functions. In some embodiments the link server 150 collects data from other wireless components of the system, connecting via one or more access points 102, wherein the access points 102 are deployed throughout the growth facility so that there are no “blind spots” for data and control. For example the link server may receive requested air or water sensor data from the WAND 160. The WAND 160 is coupled to the collar 170 for data from ACE 181 on an RS-485 bus 205 (FIG. 2) enabling data, status and such related to the entire atrium 190 via the WAND Wi-Fi link.

When a WAND 160 is installed in a collar 170 a pairing procedure may command the WAND 160 to interrogate an ESN in the collar, thereby matching the WAND 160 with the collar 170, thereby the atrium 190 for which the WAND 160 provides data. In some embodiments a controller in the WAND 160 has been set up by the link server 150 to report various sensor data per a schedule. In other embodiments the link server 150 requests sensor data when it wants it, which may be in place of or in addition to the schedule in place in the WAND.

In a similar fashion, the link server 150 may provide ON/OFF pattern data to the controller 310 in the ACE 181 for scheduling the operation of the water pumps 255, 260, 240, 245, 250 or the ON/OFF times for the mister transducers. As with the WAND, the ACE 181 controller 310 functions may be per patterns and schedules commanded by the link server, or a local function, or a combination of the two.

Data from the link server, for example the status and other information of a given atrium 190 may be provided to a wireless tablet or smart phone 120. The tablet or smart phone 120 may be used the other way as well. That is, to send commands to the link server. For example, the link server 150 could be commanded to turn all lights ON or OFF. A camera 130, either dedicated or a camera that may be included in a smart tablet or phone 120 may interrogate a QR code sticker on an atrium 190 or a LEF 110, thereby to cause an association with an atrium 190 and a newly installed WAND 160. In some embodiments QR stickers are placed on various known positions in a facility and, again, making the location of the QR code known. For example, the camera 130 may be used to report the position of a portable sensor, such as a system for determining ambient temperature, by scanning the QR code sticker on a nearby atrium 190.

The access points 102 may connect to a router 101, which would take care of such network duties as assignment of DNSs to all devices in the LAN. A factory console 104 may connect to the link server 150 through the router for the purpose of getting data, status, downloading recipes, and even insuring that the link server 150 is healthy.

In some embodiments atriums 190 are installed adjacent to each other, for example nine in a row. This configuration is referred to as a “master/slave” arrangement. This may provide for several advantages. For example, each atrium may include a siphon tube between each atrium in line. Installation may be accomplished by filling two adjacent atrium units 190 with the desired amount of water, then priming the siphon tube with a mechanical priming tool. This would be done in sequence until the end of a row, for example nine atriums 190, then the tube exiting the last atrium 190 may be returned to the water siphon input of the first atrium 190, thereby completing a water circuit. A pump 245 may keep the water flowing between units, thereby keeping water from becoming stagnant or gross variations between atriums 190. In some embodiments only one WAND 160 has water and air sensors, the other atriums 190 being equipped with WAND 160 units which are only for communication.

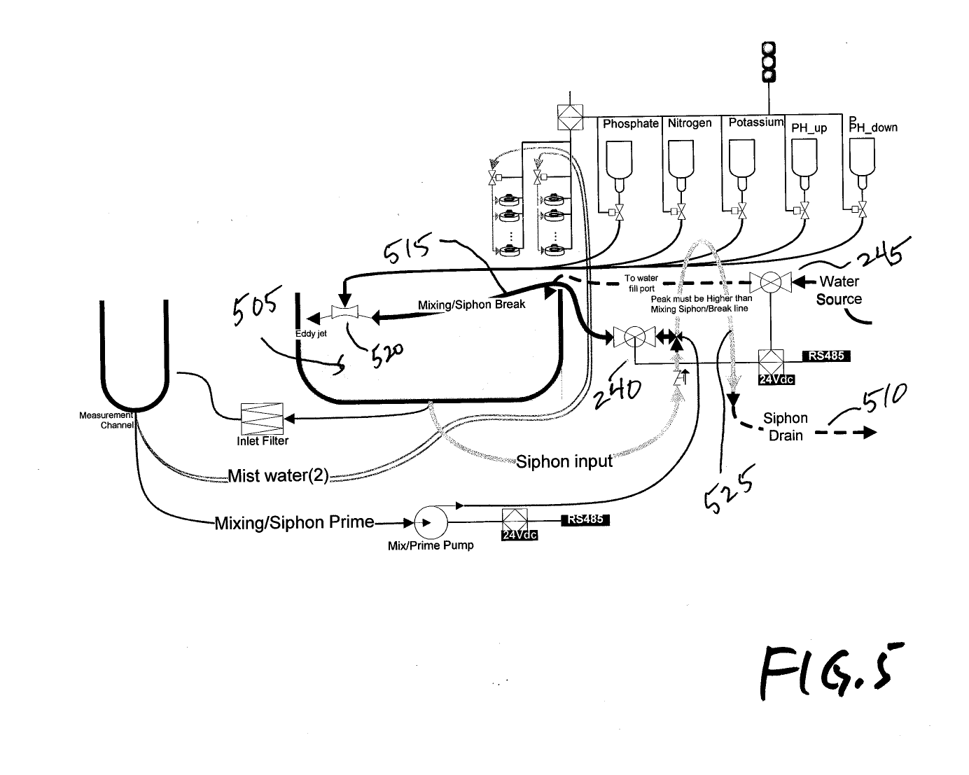

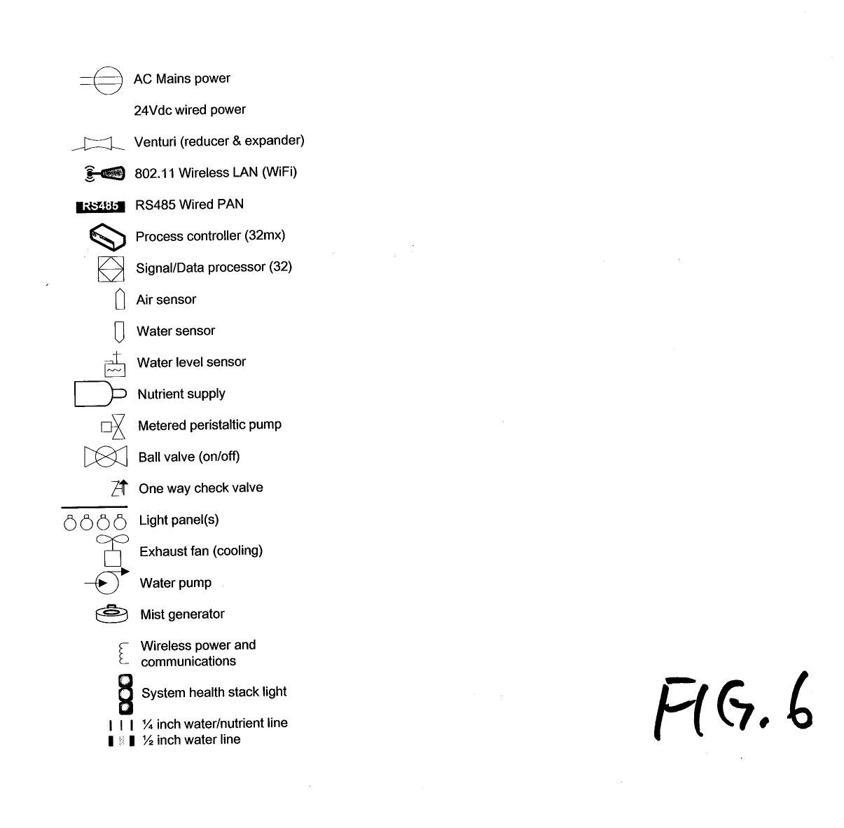

FIG. 5 provides details of the master/slave configuration. FIG. 6 is a table of the meaning of various symbols used by FIG. 5

When water from the pump 245 is to be directed to mix in nutrients and/or stir the tank 505 for measurements, the mixing/siphon break valve 240 is opened and the pump 245 is switched on. Since the siphon drain line 510 requires a higher water head than the mixing/siphon break line 515 and the check valve will prevent back flow, water flows through the open valve through the eddy jet and back into the tank 505.

When a water drain process is initiated, the mixing/siphon break valve 240 is closed and the pump 245 is switched on. A check valve will prevent back flow while the siphon primes. Falling water levels inside the tank, as measured by the water level sensor 320, will confirm that the siphon drain 510 is primed and running. At this point the check valve will have opened and draining will continue with the pump switched off.

If a drain operation is to be partial, the siphon may be interrupted by opening the mixing/siphon break valve 240. Since the eddy jet 520 is always above the water line, the open valve will introduce air to the siphon, terminating the drain operation.

In some embodiments the inlet filter and measurement channel and pump are inside a “pump bag” inside the main mixing tank. A pump bag is commonly used in swimming pools as a pre-filter for a pump. It is simply a bag made out of filter material. In one embodiment it is just a bag which is open at the top, above the water line that provides a filtered area of water within the main tank 505.

The siphon input picks up inside the tank 505 and the check valve is close to the pickup end of the Siphon input line. The siphon drain (top end of the siphon) rises over the edge of the tank 505.

Note that the siphon input is not inside the pump bag so that the tank can drain at max rate, even if the pump bag is fouled. The pump is inside the pump bag to protect the pump. The pump input and the siphon input are not the same line and the check valve is not in the pump input. Since the Siphon input tube is inside the tank, the mixing/siphon break valve is also inside the tank above the water line but below the edge of the tank and importantly BELOW the peak of the siphon drain tube. This is also true for the mixing/siphon break line 515, the venturi and eddy jet 520.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A wireless control and communications system for an aeroponic plant growth system, comprising:
a WAND unit, operatively coupled to a collar for power and communications, wherein the WAND includes wireless communications capability;
the collar, wherein the collar is affixed to an atrium enclosure and is electrically connected to an electronic control system within the atrium;
a wireless link server connected to an access point;
the access point, wherein the access point is electrically connected to a router wherein the router is connected to the internet cloud; and
a LEF unit, wherein the LEF controls lights and a fan.
